(19) United States
(12) Patent Application Publication
(10) Pub. No.: US 2018/0054228 A1
(43) Pub. Date: Feb. 22, 2018

(54) TELEOPERATED ELECTRONIC DEVICE HOLDER

(71) Applicant: I-Tan Lin, Los Angeles, CA (US)

(72) Inventor: I-Tan Lin, Los Angeles, CA (US)

(21) Appl. No.: 15/446,616

(22) Filed: Mar. 1, 2017

Related U.S. Application Data
(60) Provisional application No. 62/375,566, filed on Aug. 16, 2016.

(51) Int. Cl. H04B 1/3888; F16M 11/18; F16M 11/06; H04M 1/02; H04N 7/14; H04N 5/232; H04N 5/225

(52) U.S. Cl. CPC H04B 1/3888; F16M 11/18; F16M 11/06; H04N 2007/145; H04N 7/142; H04N 5/23206; H04N 5/2251; H04M 1/0202

(57) ABSTRACT

The present invention is a teleoperated device holder for video communication between two parties. The device holder retains a device capable of video-telephony, such as a phone. The holder allows a remote user to control the holder. The teleoperated device holder can be used in conjunction with existing video-telephony applications and software. In the preferred embodiment, the remote user controls the holder via an encoded video produced by a paired software application. The encoded video is then transmitted through the preferred video-telephony service. The holder is further provided with a sensor to receive the encoded video and translate the encoded messages to the motors of the holder, causing the holder to move the device as specified by the remote user.

### CROSS-REFERENCE TO RELATED APPLICATION(S)

The present application claims priority to U.S. Provisional Patent Application No. 62/375,566 filed on Aug. 16, 2016, entitled “TELEOPERATED ELECTRONIC DEVICE HOLDER” the entire disclosure of which is incorporated by reference herein.

### BACKGROUND OF THE INVENTION

### 1. Field of Invention

The present invention relates to a holder for electronic devices with movements that may be controlled remotely for video-telephony.

### 2. Description of Related Art

Since its first commercial use in the late 1930s, video-telephony has sought to create an immersive experience to simulate face-to-face conversation across great distances. In the early 1970s, AT&T's “Picturephone” allowed analog video and audio transmission over short distances. At the time, the Picturephone was thought of as a revolutionary system of communication when both parties could not meet face-to-face.

Video-telephony allows for better communication as users are able see one another's facial expressions, body language, hand gestures, and in some cases sign language. Modern advancements in video-telephony have popularized videoconferencing. In which, business meetings can be held among multiple parties from multiple locations around the world. Simultaneous two-way video and audio transmissions allow for a live collaboration in business, school, and personal settings to be carried out as if the parties were in the same room.

In more complex situations, the need to remotely operate a videotelephone device may be required. Military drones and NASA rovers are two examples in which a user can remotely control, or teleoperate, a device capable of video-telephony to achieve a first person view over a great distance. Teleoperation can allow remotely controlled investigation and intervention in circumstances which can be considered dangerous or impossible for a person to be placed in. Although convenient, most teleoperated devices are extremely complex and costly.

Present day video-telephony is readily accessible to almost anyone with a mobile device capable of accessing the internet. Mobile electronic devices can be used in conjunction with applications, which access the cameras and microphones of the device, to allow two or more parties to engage in a video-telephone conversation using wireless internet connections.

Currently, engaging in a modern video-telephone conversation requires the user to hold the device, use a fixed camera, or fix the device to a mount. This limits the perspective of the other party to the angle the user holds the camera, or to the angle that the camera is fixed at. In turn, neither party has control of the perspective being displayed on his or her screen, as it is determined by the other user or mounted angle of the camera.

Based on the foregoing, there is a need in the art for a means to remotely control the perspective of a device being used in during a video-telephony communication by a user on the other end of the communication.

### SUMMARY OF THE INVENTION

The present invention is a teleoperated device holder. In the preferred embodiment, the holder is provided with a base. The base is to remain stationary during operation, and is placed on a stable surface. A first motor is provided with a drive shaft, which attaches to the base of the holder. In the preferred embodiment, the body of the first motor is secured onto the floor. In the preferred embodiment, the arrangement allows the floor rotates about the center of base, when the first motor is activated.

In the preferred embodiment of the present invention, the teleoperated device holder is further provided with a second motor. In the preferred embodiment, the second motor is mounted on top of the first motor and rotates with the body of the first motor and the floor when the first motor is activated. Additionally, all electronic components are mounted to the floor, and rotate with floor to prevent the internal wiring from wrapping or twisting.

The holder is further provided with a mounting bracket, which extends from the second motor to a device mount, wherein a user device may be secured into the device mount. The arrangement is provided such that activation of the second motor redirects the camera of the mounted device up or down, relative to the base.

The device mount is further provided with a sensor array. In the preferred embodiment, the sensor array is pointed back at the mounted device and receives encoded information from the mounted device. The sensor array receives the encoded information and activates the first and second motors to reorient the mounted device.

In the preferred embodiment, the sensor array is comprised of light sensors which detect encoded messages from the display of the mounted device. In another embodiment, the sensors may be audio sensors or vibration sensors.

In an embodiment, the encoded video is created by a remote device and transmitted from the remote device to the mounted device on the holder through a paired software application. The holder allows the remote user to reorient the mounted device in a video-telephony communication.

In another embodiment, the teleoperated device holder is further provided with a face tracking feature. In the embodiment, the mounted device uses facial recognition to send encoded messages to the holder, such that the face of the user is always captured by the camera of the device in a video recording or video-telephony communication.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the teleoperated electronic device holder with the casing shown, according to an embodiment of the present invention;

FIG. 2 is a perspective view of the teleoperated electronic device holder with the casing not shown, according to an embodiment of the present invention;

FIG. 3 is a perspective view of the sensor array component of the teleoperated electronic device holder, according to an embodiment of the present invention;

FIG. 4 is a flowchart depicting the operation of the teleoperated electronic device holder, according to and embodiment of the present invention;

FIG. 5 is a flowchart depicting the operation of the teleoperated electronic device holder, according to and embodiment of the present invention; and

FIG. 6 is a flowchart depicting the operation of the teleoperated electronic device holder, according to and embodiment of the present invention.

### DETAILED DESCRIPTION OF PREFERRED EMBODIMENTS

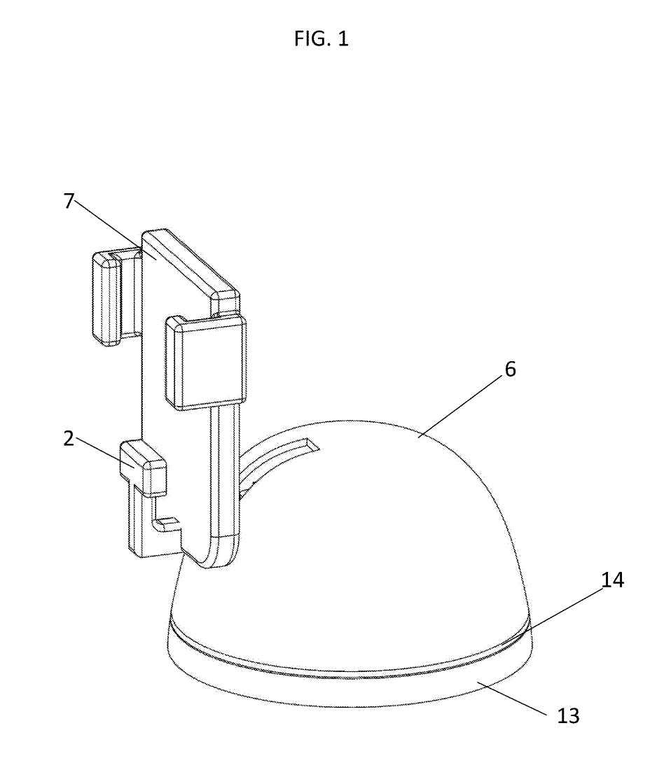

Preferred embodiments of the present invention and their advantages may be understood by referring to FIGS. 1-6, wherein like reference numerals refer to like elements.

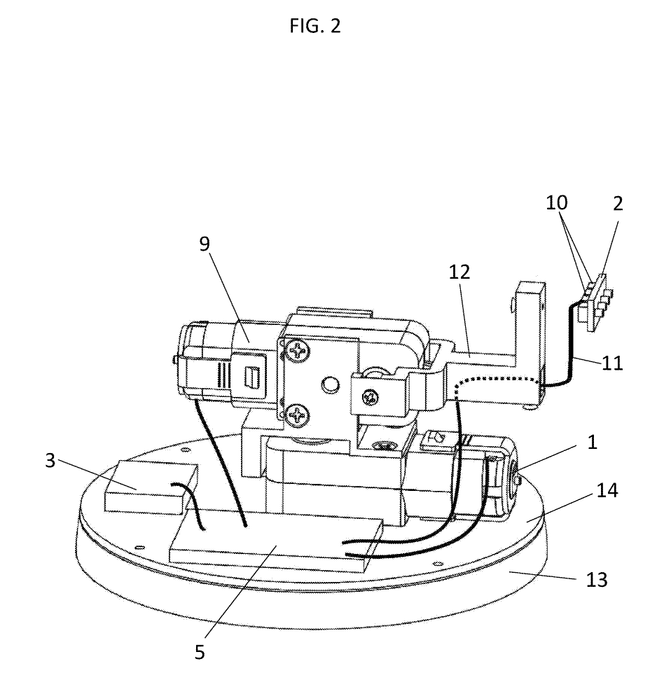

With reference to FIG. 1 and FIG. 2, the teleoperated electronic device holder is shown with a device mount 7. In an embodiment, the device mount 7 is adapted to engage a phone, tablet, or other interactive devices. In an embodiment, the mount 7 is adjustable to engage a multitude of devices capable of video-telephony function, as is known in the art. Protruding from the mount 7 is a sensor array 2. The sensor array 2 may also act as an arm to help support a device and retain said device within the mount 7. The mount 7 is attached onto a top motor 9 via a mounting bracket 12, which may adjust the angle of the mount 7, relative to the ground. The top motor 9, is fixed to a second, bottom motor 1. The bottom motor 1 rotates the mount 7 and floor 14 about the center of the teleoperated electronic device holder. The motors and sensor array are wired to the integrated circuit (IC) of the printed circuit board (PCB) 5. A battery 3 provides power to the PCB 5, which in turn provides power for the top motor 9, the bottom motor 1, the IC, and the sensor array 2.

The floor 14 is provided to secure the bottom motor 1, the battery 3, and the PCB 5. The casing 6 provides protection for said components. The wires connecting all of the components are also contained within the casing 6. In an embodiment, the casing 6 has a cutout provided, wherein the mounting bracket 12 extends from the top motor 9 and attaches to the back of the mount 7. In one embodiment, the slits allow the mount to be positioned at a 0-90 degree angle relative to the floor. In another embodiment, the slits allow the mount to be positioned at a 0-180 degree angle relative to the floor. This particular embodiment can be useful for devices with auto-orientation capabilities, where the display is always upright relative to the ground.

In an embodiment, the base 13, floor 14 and casing 6 are provided such that the base 13 is to remain stationary, while the floor 14 and casing 6 rotate about the center of the teleoperated electronic device holder. In the embodiment, the body of bottom motor 1 is secured to the floor 14, while the drive shaft (not shown) of the bottom motor 1 is engaged with the base 13. The weight of the base allows for the components of the holder to rotate, due to the rotation of the drive shaft of the bottom motor 1, while the base remains stationary

In an embodiment, the battery 3 will provide a 5V DC charge. In other embodiments, the battery will provide the voltage charge necessary to complete the desired functions. The present invention should not be limited to one operating voltage. The battery may be rechargeable and may be a Lithium-Ion, Titanium, Nickel Cadmium, Nickel-Metal Hydride, Lithium Polymer or other battery types able to be recharged. In another embodiment, the battery 3 will be replaceable alkaline cell batteries or other replaceable battery types. In an embodiment, the battery 3 will be able to be charged through a port (not shown). The port type may be micro-USB or another type of port that is suitable for charging the battery 3 and powering the device. In an embodiment, said port will also allow a user to access the PCB of the teleoperated electronic device holder so that the user may have the option to adjust various settings of the teleoperated electronic device holder. Such settings may include rate of movement, sensor configuration, sensor calibration, or other settings considered to be applicable to the device.

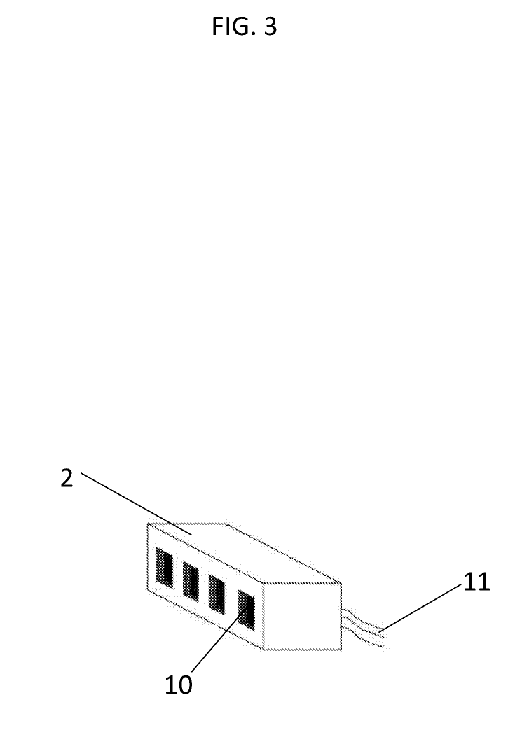

In the preferred embodiment, with reference to FIG. 3, a sensor array is shown containing four light sensors 10. In an embodiment, each light sensor comprises of two or more wire leads 11. At least one wire for a positive connection, and at least one wire for a negative connection. These leads are connected to the PCB, which sends the signal to the IC, which is in turn connected to the battery.

In the preferred embodiment, each light sensor will read light emitted from the device screen, and each sensor can function as an on/off switch (or 0 and 1 in binary code). Where four sensors are used, 16 different messages received by the sensors, and each message will be assigned a motor operation. This allows 16 different movements or actions to be assigned to each message.

In another embodiment, the light sensors are able to detect multiple intensities, frequencies, and/or durations of light allowing for a single sensor to control one or more directional movements. In said embodiment, the display of the device will project a specified light intensity, frequency, and/or duration onto the sensors. The sensors will send the signal to the PCB, which will interpret the specified light intensity, duration, and spectral range, the PCB will then send the interpreted signal to the IC which will activate the motors to move the mount in the specified direction.

In another embodiment, the sensor array 2, is made up of one or more audio sensors which are set to a particular frequency threshold. Upon receiving a frequency at the appropriate threshold, the sensor will trigger the PCB which, in turn, will activate the appropriate motor to move in a specified direction. In one embodiment, one sensor may be setup to receive multiple audio frequency thresholds and activate the appropriate motor to move the mount in the desired direction. In another embodiment, the sensor array will comprise of multiple sensors. Each sensor will be assigned to activate a motor to move the mount in the desired direction. In an embodiment, the frequencies to activate the sensors are out of the human threshold of hearing as to allow conversation between the two parties on either end to continue uninterrupted while control signals are transmitted and processed.

In an embodiment, quick commands will enable an automatic positioning on the mount. Such quick commands may include a 180-degree command, in which the mount is automatically rotated 180 degrees about the central axis of the holder.

In a preferred embodiment, the teleoperated electronic device holder is to be used in conjunction with a software application that the user downloads on his or her selected device. The software application may be as simple as an application that produces a small bar on the display of the user's device. The bar may produce the control signals that the sensor array receives. In a preferred embodiment, the control signals are four square boxes on a bar that change from a dark to light color in order to transmit a light intensity to activate the sensors. In an embodiment, the user on the other end would be able to engage directional arrows to increase the light intensity of the boxes of the device placed in the teleoperated electronic device holder. In another embodiment, the application would work with a computer or phone input such as a keyboard, mouse, touchscreen, and/or motion sensor so the user may activate control signals.

In an embodiment, the software application used in conjunction with the teleoperated electronic device holder will be an add on and can be used on top of existing applications such as skype, google chat, facetime, or other applications with video-telephony capabilities. In another embodiment, the software application used in conjunction with the teleoperated electronic device holder will be its own standalone application. In said embodiment, the user will download the software application which will access the device's camera, microphone, and Wi-Fi connection to enable a video-telephony chat. Part of the application will be dedicated to a display bar with the control signals being activated on one end and engaged on the other end.

In an embodiment, the software application used in conjunction with the teleoperated electronic device holder will be able to enter into an emergency mode. In which, an emergency operator will be able to control the teleoperated device holder from a computer. In emergency mode, the emergency operator may be able to record the transmitted video and audio received from the device. This would allow a surveillance and video record of the emergency situation. Furthermore, the emergency operator would be able to control the perspective of the video transmittance being recorded.

In a preferred embodiment, the top motor 9, and the bottom motor 1 work independently. But together they allow for the mount 7 to be adjusted to up, down, left, or right. In an embodiment, the motors may be activated at in a one-at-a-time fashion, allowing for only one directional movement at a time. In another embodiment, both motors may be activated at the same time allowing for a diagonal or in-between directional movement.

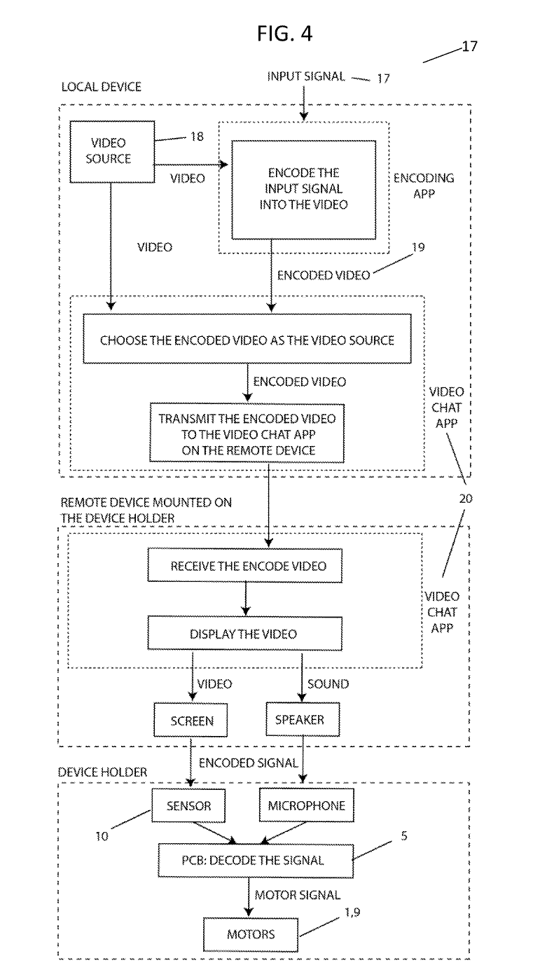

In reference to FIG. 4, a flowchart is shown depicting the operation of the teleoperated device holder. The operation of the device holder begins when a transmitting user, herein referred to as the transmitter, creates an input signal 17 from their local device. The input signal 17 may be a mouse movement, keyboard action, trackpad movement, or signals generated by other software or hardware installed on the local device. The local device is provided with a video source 18, such as an integrated video camera. In the preferred embodiment, the video source 18 is combined with input signal 17 to create an encoded video 19.

In the preferred embodiment, the user then chooses the encoded video 19 as the video source for their preferred video chat application 20. The encoded video 19 is then received by a receiving user, herein referred to as the receiver, on their device via the video chat application 20. The receiver's device is mounted to the teleoperated device holder and displays the encoded video. In the preferred embodiment, the sensor array 2 picks up the input signals from the encoded video and transmits them to the PCB 5 of the teleoperated device holder. The PCB 5 then decodes the signals received by the sensors 2 and transmits the appropriate signal to the top motor 9 and bottom motor 1 to move the device as directed by the input signal 17 controlled by the transmitter.

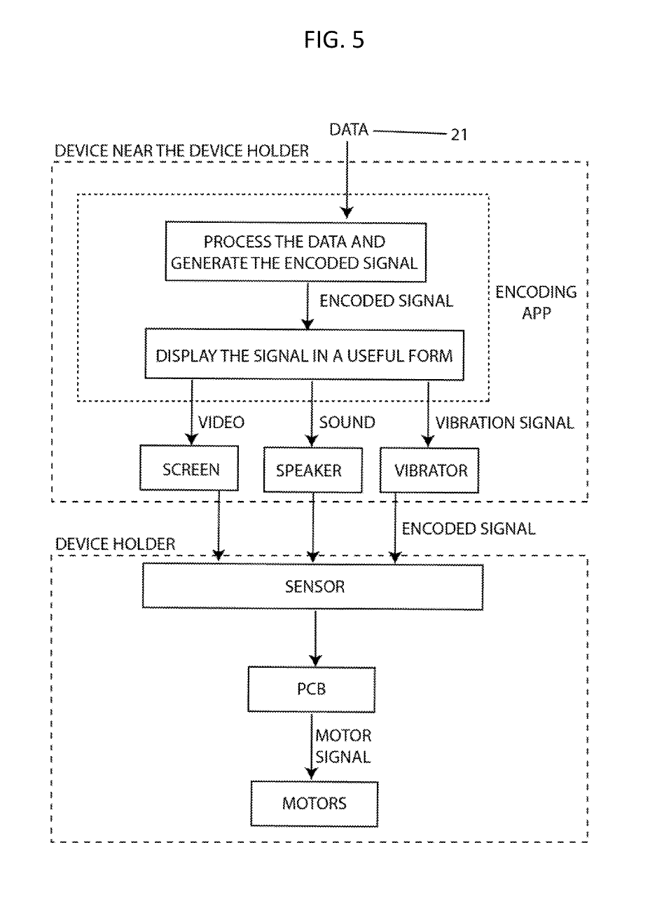

In reference to FIG. 5, a flowchart is shown to depict the operation of the teleoperated device holder, wherein the device holder is remotely controlled by a nearby device. In the embodiment, input data 21 is received by the nearby device, human input, or data received from another device. The data is processed by the nearby device and emitted towards the device holder. The signal emitted by the device may be an image, sound, or vibrational signal. The emitted signal is then captured by the sensors 10 of the device holder, transmitted to the PCB 5, and sent to the top motor 9 and bottom motor to move the receiver's device as desired.

In an embodiment in which a sound sensor is used, the operation process is the same, however the encoded video emits a sound to be picked up by the sensors 10 instead of a light.

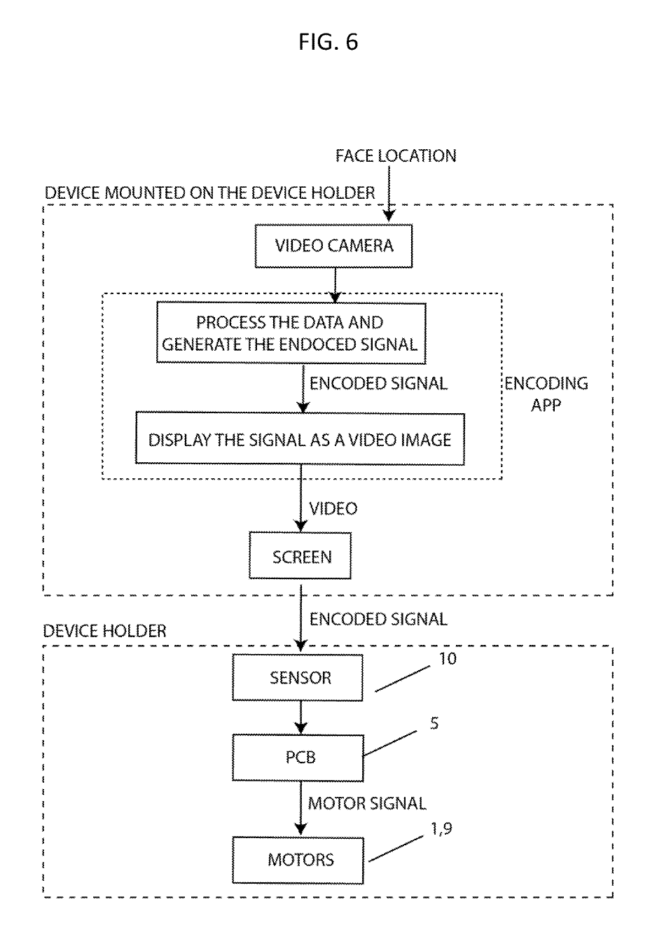

In reference to FIG. 6, a flowchart is shown to depict the operation of the face tracking feature, according to an embodiment of the present invention. In the embodiment, a provided application will recognize a receiver's face within the image captured by the device camera, as is known in the art. As the receiver's face moves towards the perimeter of the image, the application will generate an encoded video to be received by the sensors 10. The sensors 10 will transmit the encoded signal to the PCB 5, which will signal the motors to move the device in the holder, such that the receiver's face is placed into the center of the image.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A teleoperated device holder having:
a. a base configured to rest stably on a surface;
b. a first motor having:
i. a drive shaft engaged with the base;
ii. a body secured to a rotatable floor;
c. a second motor mounted directly to the top of the body of the first motor;
d. an L-shaped mounting bracket extending from the second motor to a device mount;
e. a sensor array including a plurality of sensors protruding from the device mount, wherein a device is placed in the device mount to allow the sensors of the sensor array to detect output from the device, and wherein the output detected by the sensors of the sensor array from the device activates the first motor and the second motor to reorient the device responsive to the output detected by the sensors of the sensor array.

2. The teleoperated device holder of claim 1, wherein the sensor array is comprised of one or more light sensors configured to detect movement of a user as output by a device in the device mount and is positioned on the device mount.

3. The teleoperated device holder of claim 1, wherein the sensor array is comprised of one or more audio sensors configured to detect movement of a user as output by a device in the device mount and is positioned on the device mount.

4. The teleoperated device holder of claim 1, wherein the sensor array is comprised of one or more vibration sensors configured to detect movement of a user as output by a device in the device mount and is positioned on the device mount.

5. The teleoperated device holder of claim 2, wherein the device displays a video output.

6. The teleoperated device holder of claim 5, wherein the video output is transmitted to the device from a remote device.

7. The teleoperated device holder of claim 6, wherein the video output is created using a software application.

8. The teleoperated device holder of claim 1, further comprising a face tracking feature.

9. The teleoperated device holder of claim 1, further comprising a casing over the first motor and second motor, having a cutout through which the L-shaped mounting bracket extends.

10. The teleoperated device holder of claim 1, wherein the casing is hemispherical.

11. The teleoperated device holder of claim 1, wherein the cutout is configured to allow the mount to be positioned at a 0-90 degree angle relative to the floor.

12. A teleoperated device holder having:
a. a base configured to rest stably on a surface, the base configured to remain stationary on the surface;
b. a first motor having:
i. a drive shaft engaged with the base;
ii. a body secured to a rotatable floor;
c. a second motor mounted directly to the top of the body of the first motor;
d. an L-shaped mounting bracket extending from the second motor to a device mount, the device mount configured to receive a device;
e. a sensor array including a plurality of sensors protruding from the device mount, wherein the sensors of the sensor array to detect output from a device when a device is placed in the device mount, and wherein the output detected by the sensors of the sensor array from a device when a device is placed in the device mount activates the first motor and the second motor to reorient the device responsive to the output detected by the sensors of the sensor array.
